(19) United States
(12) Patent Application Publication
(10) Pub. No.: US 2020/0393120 A1
(43) Pub. Date: Dec. 17, 2020

(54) WINDOW WITH LIGHTING UNIT

(71) Applicant: SIGNIFY HOLDING B.V., EINDHOVEN (NL)

(72) Inventors: MARTINUS PETRUS CREUSEN, WIJLRE (NL); MICHEL CORNELIS JOSEPHUS MARIE VISSENBERG, ROERMOND (NL); TIES VAN BOMMEL, HORST (NL); ROBERT JACOB PET, WAALRE (NL)

(21) Appl. No.: 16/970,934

(22) PCT Filed: Feb. 14, 2019
(86) PCT No.: PCT/EP2019/053678

§ 371 Date: Aug. 18, 2020

(30) Foreign Application Priority Data
Feb. 20, 2018 (EP) 18157681.0

(51) Int. Cl. F21V 33/00; E04D 13/035; E06B 7/28; F21S 19/00; F21V 23/04

(52) U.S. Cl. CPC F21V 33/006; E04D 13/0354; F21V 23/0471; F21S 19/005; F21V 23/0464; E06B 7/28

(57) ABSTRACT

A window has a lighting unit provided along a bar handle for use in opening the window. The lighting unit is for illuminating the window pane, for example when it is dark outside. This is of particular interest for roof windows (e.g. skylights). The lighting prevents the dark appearance of the window pane.

### FIELD OF THE INVENTION

This invention relates to windows, and in particular windows with integrated lighting units.

### BACKGROUND OF THE INVENTION

Roof windows (for slanted roofs) as well as skylights (for flat roofs) are used in buildings so that during the day natural light provides effective indoor lighting. However, at night a roof window will appear black and does not provide light. Presently, window blinds and screening devices are used to reflect indoor light at night. If the window blinds are not in use or not installed the light is lost through the window and the window appears black. If there are window blinds, they mask the dark appearance of the window pane, but they also appear dark themselves, and of course they do not function as a light source.

The darkness of a roof window during night time, and the desire for a window to function as a source of light, may be solved by providing artificial lighting at the window. However, direct artificial lighting, such as a visible light source mounted on the window frame providing light outwardly from the window, would be very uncomfortable and glary. This is because a window is usually positioned in the field of view (such that one can have a view to the outside). Thus, there would typically be a direct view of the light source.

Indirect lighting of the window or a blind over the window and the window cove would be preferable, by directing light towards the window. However, if an indirect light source is mounted directly on the window frame, the lighting effect of the resulting very shallow angle light (known as grazing light) on the window pane or window blind is rather unattractive. For example, this grazing light reveals all ripples and defects in the window blind.

There is therefore a need for a lighting solution to improve the aesthetic appearance of a window during outside darkness by providing illumination in a most effective way.

DE20201000087 discloses a light-emitting unit which can be used as a handle. The light-emitting unit has a hollow body that forms the part of the handle that can be fastened with one or more foot parts to a door, a drawer or a window, such that the hollow body is located at a distance from the door, drawer or window. LEDs are provided within the hollow body in such a way that each LED is flush with an opening in the hollow body. Also provided within the hollow body is a power source, such as a battery, and a switch, for operating the LEDs.

### SUMMARY OF THE INVENTION

The invention is defined by the claims.

According to examples in accordance with an aspect of the invention, there is provided a window comprising:

a window pane;

an inner frame around the window pane, the inner frame having a first edge;

an outer frame, wherein the inner frame is openable within the outer frame;

a handle in the form of a bar extending along the first edge of the inner frame for use in opening the inner frame, wherein the handle is spaced at a perpendicular distance from the window pane; and

a lighting unit provided along the handle for providing illumination towards the window pane, wherein the lighting unit is arranged to emit an output beam having a principal output direction, the principal output direction being at an angle with a plane parallel to the window pane, wherein the angle has a maximum value of 20 degrees, preferably a maximum value of 10 degrees.

This window includes a lighting unit mounted on, or integrated in, a bar handle used for opening the window. It projects light onto the window pane or onto a blind over the window pane so that in dark outside conditions, the black window pane appearance or dark blind appearance is avoided. This is of particular interest for non-vertical windows, such as roof windows. By providing lighting from a raised platform, a more uniform lighting effect is possible, and glare is more easily prevented. The lighting unit typically comprises an LED array.

By having the principal output direction which is within 20 degrees, preferably within 10 degrees, of a plane parallel to the window pane, the light is designed to give the best reflection while avoiding glare. In particular, the light output is generally parallel to the window pane to ensure total internal reflection of the light provided to the window pane (for example off the rear face of the pane). The principal output direction is the direction within an overall output beam in which the intensity is highest. Thus, it may be considered to the general output direction of the beam. For an elongate light source, the principal output direction may be a plane.

The handle bar for example extends by more than 60% along the first edge (i.e. more than 60% of the width of the window pane), preferably more than 80%, and most preferably more than 90% including up to 100%, to enable a uniform illumination of the window.

The handle may be spaced from the first edge by 1 cm to 20 cm, for example by 5 cm to 10 cm. In other words, the perpendicular distance between the handle and the window pane may be in the range of 1 cm to 20, for example in the range of 5 cm to 10 cm. The handle may have a front face that when in the closed position is substantially parallel to the window pane. The handle may have at least one pivot that is parallel to the lower edge of the handle bar. To open the window, a user grips the handle bar and pulls in a downwards direction. This action will rotate the handle bar about the at least one pivot and the front face that was previously substantially parallel to the window pane (in the closed position) will be at an acute angle to the window pane.

The handle position provides sufficient spacing from the window to enable an output beam to provide illumination of the full window pane with sufficient uniformity to provide an aesthetically pleasing appearance.

The lighting unit for example has an output beam with a half width half maximum on a side facing the window pane of less than 10 degrees.

This half width maximum is preferably less than 5 degrees, and even more preferably less than 4 degrees such as for example 3 degrees. The narrower the angle, the better the reflection properties.

This low beam angle provides a large area illumination over the window pane. The lighting unit may deliver a symmetric output (i.e. with the same half width half maximum on both opposite sides) or it may deliver an asymmetric output.

The lighting unit may have an output beam with a half width half maximum on a side facing away from the window pane in the range 3 to 45 degrees.

In one preferred implementation of an asymmetric output, the lighting unit has an output beam with a half width half maximum on a side facing the window pane of less than 10 degrees and a half width half maximum on a side facing away from the window pane in the range 15 to 45 degrees. This asymmetric beam profile illuminates the window uniformly without inducing glare in the room, as well as provided good illumination in the room.

In particular, in the direction away from the window pane, the lighting unit may generate general lighting. Thus, the lighting unit may be used to provide different lighting functions towards the window pane and away from the window pane.

The lighting unit output may have a principal output direction of the output beam which is directed from the lighting unit to a second edge of the inner frame, the second edge being opposite to the first edge. This ensures that the full area of the window pane is illuminated.

The lighting unit may have an output beam with a cut-off angle with respect to the principal output direction of less than 70 degrees in the direction away from the window pane.

This ensures that the light facing away from the window pane does not give rise to direct glare. For example, for the steepest typical roof slope of 30 degrees, this means light is within 40 degrees to the vertical.

The lighting unit may be used to generate a polarized light output such as an S-polarized light output. An S-polarized light output may be used to result in more efficient reflection from a glass window pane.

The window pane (or blinds over the window pane) may comprise a reflective polarizer. This may further enhance the efficiency of the reflection. Any polarization may be used to match a corresponding polarization of the light output.

The window may further comprise blinds or curtains to be illuminated by the lighting unit. Such blinds may be on the outside of the window or on the inside of the window. The lighting unit may for example be programmed to switch on or off upon closing/opening of the blinds or curtains. The lighting unit may for example adjust the color of the light to the color of the window blind fabric. For example, a blue window blind could be illuminated with more bluish light to enhance the color and save energy by reducing the absorption by the blind.

The window may further comprise:

a presence detection unit and/or an ambient light detection unit; and

a controller for controlling the lighting unit in dependence on the ambient light detection and/or presence detection.

In this way, the lighting unit may be operated only when needed, i.e. in the dark and when a person is present. The ambient light detection may be performed inside and/or outside the building in which the window is installed.

The window may further comprise:

an open or closed detection unit for detecting if the inner frame is open or closed; and

a controller for controlling the lighting unit in dependence on the open or closed detection.

The lighting unit may for example be turned off when the window is open, because the light may then be directed outwardly.

The lighting unit may have an adjustable beam shape. This may be used to adapt the lighting unit output to different sizes of window and different roof angles, for example. The beam shape may be controlled electronically or mechanically (e.g. by selecting suitable optics manually).

The window typically comprises a roof window, for example for mounting at an angle of between 30 and 60 degrees to the vertical. The lighting unit design preferably takes into account the intended angle of the window. The optical configuration is preferably optimized for such roof windows.

The invention also provides a handle for attachment to a window, wherein the window comprises a window frame and a window pane, and wherein the handle comprises:

a bar for mounting along one edge of the window frame, wherein the handle is adapted to be spaced at a perpendicular distance from the window pane; and

a lighting unit provided along the handle for providing illumination towards the window pane, wherein the lighting unit is arranged to emit an output beam having a principal output direction which is adapted to be within 20 degrees of a plane parallel to the window pane, preferably within 10 degrees.

This aspect provides a window handle which may be a retrofit part to an existing window (for example with an existing electrical supply).

The handle may be:

for attachment to an openable part of the window frame; or

a dummy handle for attachment to a non-openable window.

The illuminated handle may thus be applied to a window which does not open, and thus functions only as a dummy window handle.

The invention also provides a method of lighting an area of a window pane, comprising:

providing illumination towards the area of the window pane from a handle, wherein the handle extends along one edge of a frame which surrounds the area of the window pane, wherein the handle is spaced at a perpendicular distance from the window pane, and wherein the illumination has a principal output direction which is within 20 degrees of a plane parallel to the area of the window pane, preferably within 10 degrees.

This method provides effective illumination of a window pane area in dark outside conditions. The window pane area may have blinds or curtains, or it may be a bare glass pane. The spaced handle bar may be for opening the window or it may be a dummy handle.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows an example of the type of window to which the invention may be applied;

FIG. 2 shows a vertical cross section perpendicular to the plane of the window pane;

FIG. 3 shows two possible options for providing lighting;

FIG. 4 shows a first example of a preferred type of arrangement for providing lighting;

FIG. 5 shows a second example of a preferred type of arrangement for providing lighting;

FIG. 6 shows the reflection coefficient (%, y-axis) versus the angle of incidence (degrees, x-axis) for S-polarized light and P polarized light;

FIG. 7 shows that the handle may have a rotated ventilation position and a fully closed position in addition to a position in which the window is to be opened; and

FIG. 8 shows that the lighting unit may be integrated into the body of the handle.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a window in which a lighting unit is provided along a bar handle for use in opening the window or provided as a dummy handle. The lighting unit is for illuminating the window pane or blinds over the window pane, for example when it is dark outside. This is of particular interest for roof windows (e.g. skylights), which do not have hanging curtains and often do not have blinds. The lighting prevents the dark appearance of the window pane or blinds, and also partially simulates a daylight condition by giving the impression of light coming through the window.

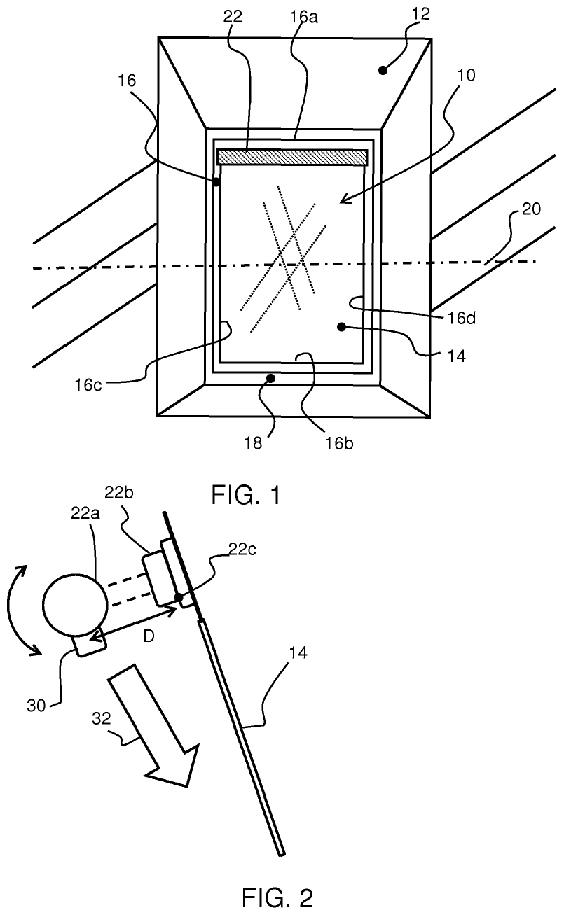

FIG. 1 shows an example of the type of window to which the invention may be applied.

The window 10 is mounted at the base of a cove 12 and comprises a window pane 14,

an inner frame 16 around the window pane and an outer frame 18. The outer frame is mounted to a surrounding structure such as a roof. The inner frame 16 may be opened and closed within the outer frame 18. Thus, the window 10 may be opened and closed. The inner frame 16 for example pivots about an axis 20 which is horizontal when the window is installed.

The inner frame has top and bottom cross piece edges 16a, 16b and side edges 16c, 16d. The outer frame also has corresponding edges. Thus, in this example, a rectangular window is defined.

To open the window, a handle 22 is provided in the form of a bar extending along one edge of the inner frame, in particular the top cross piece edge 16a. The handle may be rotated first between a fully closed position and a venting position, and then it may be rotated further into a position in which the inner frame can be pivoted open about the axis 20.

The handle for example comprises a raised bar, spaced from the window frame by a base, such that a user may grip around the raised bar, and the raised bar and the base rotate as a single unit around a pivot (not shown) which is parallel to the axis 20.

In accordance with the invention, a lighting unit is provided along the handle 22 for providing illumination towards the window pane 14. The lighting unit is not visible in FIG. 1.

The handle and its lighting unit preferably extend across the full width of the window pane. However, more generally, the lighting unit preferably extends more than 60% of the way across the window frame edge, preferably more than 80%, most preferably more than 90%. The lighting unit may extend the full length of the handle (but the handle may itself be shorter than the full window frame width) or the handle may extend across the full width, but the lighting unit may be shorter.

FIG. 2 shows a vertical cross section perpendicular to the plane of the window pane. It shows the handle 22 in side view with a bar 22a spaced above a base 22b and shows the lighting unit 30 which directs a light output 32 towards the window pane 14. The user grips the bar 22a to rotate the handle (i.e. both the bar 22a and the base 22b) and open the window. The handle rotates about a pivot axis 22c which is parallel with the length of the handle (i.e. parallel with the window axis 20). The angle of the light output 32 may change relative to the window pane 14 due to the rotation of the handle 22.

To prevent direct glare or to prevent light which is too shallow to the pane, an indirect light source is desired, and it should be placed at a distance from the window. The use of the handle prevents the light source providing an additional unwanted protrusion which could otherwise block daylight and/or be in the way when opening the window.

The handle bar is positioned close to or at the edge of the inner frame and is spaced at a perpendicular distance D from the window pane as shown in FIG. 2. The distance D is for example in the range of 1 cm to 20 cm and typically in the range of 5 cm to 10 cm.

The lighting may be used to illuminate a bare window pane, or there may be blinds or curtains over the window. Blinds may be outside the window or inside the window. In the case of a double glazed window 10, the blinds may be between the window panes.

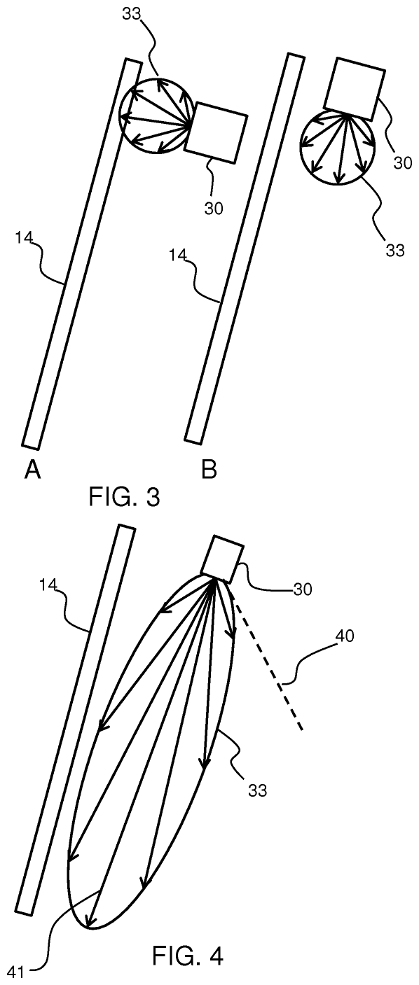

There are various design options for the lighting unit 30. FIG. 3 shows a first set of two options.

In FIG. 3A, the light source 30 faces the window pane and has a Lambertian diffuse output beam 33. This results in a concentrated bright area close to the handle bar but does have the advantage of no direct view of the light source for the viewer.

In FIG. 3B, the light source 30 directs light parallel to the window pane and again has a Lambertian diffuse output beam 33. This results in more uniform illumination of the window pane but there is a direct view of the light source which gives rise to glare for the viewer.

FIG. 4 shows one example of a more preferred type of arrangement.

The light source 30 generates a narrow beam 33, typically with a half width half maximum (HWHM) below 10 degrees on each side of a principal light output direction 41 of an output beam, namely a direction of peak intensity. The principal light output direction is for example at an angle with respect to the window pane which is in the range of 0 to 20 degrees, typically in the range of 0 to 10 degrees. Thus, the light is directed parallel or nearly parallel to the window pane. When the principal light output direction 41 is offset to the parallel, it is directed towards the opposite (bottom) end of the window pane.

The beam has a generally constant shape at different cross sections along the length of the handle bar. Thus, the principal light output direction 41 in fact defines a plane.

While, as mentioned above, the handle bar may be spaced from the window pane at a perpendicular distance D in the range of 1 cm to 20 cm, the height of the window (i.e. the distance between the cross piece edges 16a, 16b) is for example in the range of 50 cm to 180 cm. For a 50 cm window with a handle protruding by 20 cm, an angle of 21.8 degrees is needed to direct the beam to the bottom edge. This is the reason for a possible maximum angle of 20 degrees. A larger window (i.e. a window with a height larger than 50 cm) and/or a smaller protrusion distance (i.e. a perpendicular distance D smaller than 20 cm) will result in a smaller angle needed to direct the beam to the bottom edge. For a 60 cm window with a handle protruding by 10 cm, an angle of 9.5 degrees is needed to direct the beam to the bottom edge. This is why the possible maximum angle is preferably 10 degrees. The width of the window, and hence the length of the handle and lighting unit, is for example in the range 30 cm to 100 cm.

Another important characteristic of the light output is the cut-off angle of the beam. For example, it is desired to define a direction (line 40 in FIG. 4) beyond which there is no direct light from the lighting unit, in order to avoid direct glare for the viewer. This line 40 is preferably oriented less than 40 degrees with respect to the vertical direction, and more preferably less than 30 degrees. In this way, downward light is provided rather than shallow (horizontal) light, thereby to reduce glare.

The arrangement of FIG. 4 provides unobtrusive, efficient indirect internal lighting from the window surface. It may be used with a window having blinds or even when window blinds are not in use by providing improved light reflection from a standard glass window pane.

The arrangement of FIG. 4 shows a symmetric light output. The symmetry is each side of the principal light output direction. The lighting unit is preferably formed as a line of LEDs so that these principal light output directions together define a plane which represents the general light output and may be considered to be a principal light output plane of an output beam. One side of the plane faces the window pane and the other side of the plane faces away from the window pane. In the arrangement of FIG. 4, the light output shape is generally the same on these two sides of the principal light output plane, i.e. symmetrical around the longest central arrow 41.

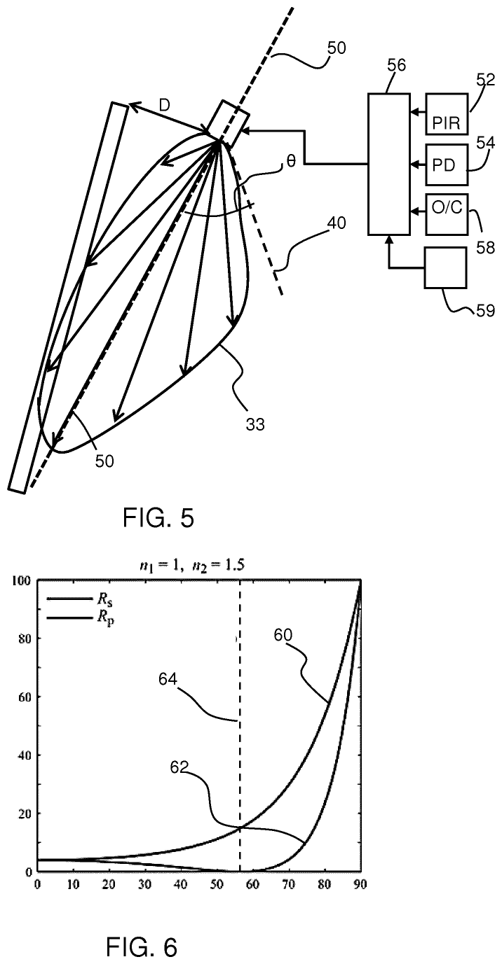

FIG. 5 shows an asymmetrical arrangement. The principal light output direction (or plane) is shown as line (or plane) 50. In this design, the output beam angle is smaller on the side of the window pane, and larger on the opposite side.

For example, the lighting unit has an output beam 33 with a half width half maximum on the side facing the window pane of less than 10 degrees (for example in the range 3 to 10 degrees, such as 5 degrees) whereas the output beam may have with a half width half maximum on the side facing away from the window pane anywhere in the range 3 to 45 degrees. The narrow beam on the window pane side creates an even light distribution. The wider beam away from the window pane for example illuminates the window cove, or the floor beneath the window.

In all cases, a sharp intensity cut-off is desired to prevent glare.

As mentioned above, the cut-off (shown by line 40) is preferably below 40 degrees offset from the vertical. A roof angle is typically in the range 30 to 60 degrees, and for a 30 degree roof angle, this 40 degree limit translates to at most 70 degrees from the plane of the window pane. In terms of the lighting unit itself, it is thus preferred that there is full cut-off of the light intensity within 70 degrees from the principal light output direction 50 on the side facing away from the window pane, i.e. angle θ is less than 70 degrees. To provide ambient lighting the angle θ (at which there is a cutoff) is more than 10 degrees, for example more than 20 degrees, for example more than 30 degrees, for example more than 40 degrees.

A further option is to use a polarized light source which emits polarized light (with the plane of incidence defined as perpendicular to the plane of the window pane). For example, S-polarized light provides more reflection from a glass window pane than P-polarized light at the lower angles of incidence (typically most light will reflect at angles beyond 45 degrees). This can further improve the efficiency of the reflection from the window pane.

FIG. 6 shows the reflection coefficient (%, y-axis) versus the angle of incidence (degrees, x-axis) for S-polarized light as plot 60 and P polarized light as plot 62. It shows the reflection from only one air to glass interface. For a double glazed window, there are two such interfaces and two glasses to air interfaces as well, which greatly increases the total reflection value. The line 64 represents Brewster's angle of total transmission of the P polarized light (through the air to glass interface).

In order to further increase the efficiency, the window pane (or blinds which are used over the window pane) may comprise a reflective polarizer to reflect the (polarized) light. This output polarization and polarization reflection function may be implemented with any type of polarization.

The light distribution can also be optimized for the handle bar position which is most used by end users.

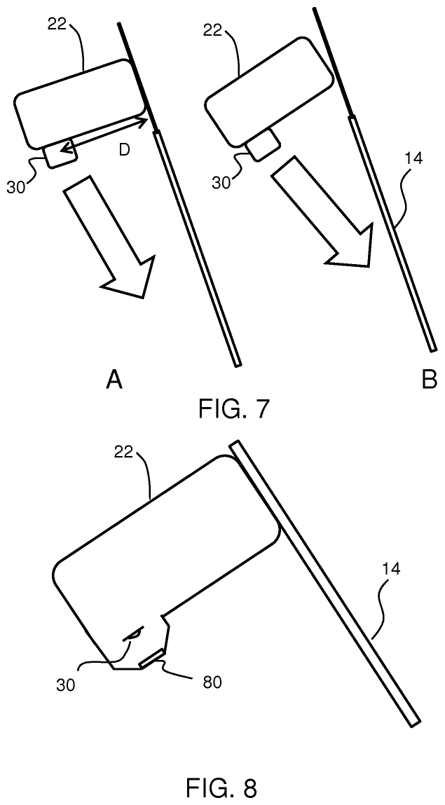

As mentioned above, the handle may have a rotated ventilation position, and this may be the most often used position. FIG. 7A shows a fully closed position and FIG. 7B shows a venting position with the handle rotated, but the window still closed (and secure).

There is also typically a third rotated position in which the window is to be opened. The handle for example comprise a pair of parallel spaced bars as shown in FIG. 2. One of these bars is to be held by the user and the gap between the bars provides space for the user's fingers. This is for example the most common arrangement for a Velux (Trade Mark) window design. For simplicity, the overall handle assembly is represented in FIG. 7 as a single block 22.

The two window positions shown in FIG. 7 are the most likely ones for which illumination is desired. It is less likely to be desired when the window is open. The handle bar or the lighting unit may be rotatable so that, between the two window settings shown in FIG. 7, the lighting unit can be rotated so that the principal light output direction remains the same. One lighting configuration may be used when the ventilation opening is closed, and the other lighting configuration may be used when the ventilation opening is opened.

For the two positions shown in FIG. 7 there are three options:

(i) To optimize the lighting conditions for one of the two positions;

(ii) To find a compromise lighting condition which can be applied for either position; or

(iii) To provide a flexible orientation of the lighting unit as a function of the handle position.

FIG. 8 shows that the lighting unit 30 may be integrated into the body of the handle 22, for example with output optics 80.

In addition to providing indirect lighting of the window pane (or blind) as described above, the same lighting unit may be used to illuminate the handle bar itself. By making the material of the handle bar slightly transparent, the bar can light up in the dark. This guides the eye in the case of full darkness in order to find the handle bar more easily or it may be used as an indicator light to show that the ventilation function is used.

Instead of a glowing handle bar, the handle bar may have a second, diffuse source aimed at the window to provide a subtle glow around the handle bar.

The embedded lighting function may be combined with an absence/presence detector and/or a light sensor embedded in the handle bar or in another part of the window frame. This can help to reduce the energy usage. For example, based on both the sensor and detector signals, the lighting unit may only be actuated when both the ambient light level in the room is sufficiently low and the absence/presence detector detects presence in the room.

FIG. 5 shows the components required for this variation. It shows a presence detection unit 52, an ambient light detection unit 54 and a controller 56 for controlling the lighting unit in dependence on the ambient light detection and presence detection.

In another variation, the lighting unit may be switched off when the window is opened since in that case the light will be directed outwards. To avoid light spill to the environment, a straightforward detection method can be used to detect that the window is opened and consequently the lighting unit will be switched off.

FIG. 5 also shows an open or closed detection unit 58 for detecting if the inner frame is open or closed and providing the detection signal to the controller 56.

As another example, a sensor 59 may also detect the angle of the window and in response provide a different lighting setting.

A further example is for the lighting to be programmed to switch on or off upon closing/opening the blinds or curtains. For this purpose, the open or closed detection unit 58 may additionally detect the state of the blinds or curtains.

The lighting may also be adjusted in color as a function of the color of the window blind fabric to enhance the color and save energy by reducing the absorption by the blind.

The examples above are based on a static fixed light output. However, the roof angle, window size, window angle (open or closed), the handle bar design, and the window settings (such as the closed setting, ventilation setting and open setting) will differ for different window type and building types. The beam shape may be made adjustable so that a single design is suitable for different window designs and different installations. Adjustments may be made to the direction of peak intensity (i.e. the principal light output direction as discussed above) depending on the orientation of the handle bar and/or the orientation of the window. The width of the beam (or the two widths in case of an asymmetric beam) may be made adjustable, and it may also be possible to set the direction of the glare cut-off angle, depending on the roof angle, window orientation and handle bar orientation.

These adjustments may for example be made mechanically by replacing, rotating or sliding optical elements such as lenses or reflectors or blocking shields with respect to the source. This may be manual, or motor driven. Instead, electronic adjustments may be made by controlling the brightness of individually controllable light sources within the lighting unit, with those light sources having different intensity profiles.

The adjustments can be made by the user or automatically based on sensor input, for example based on sensing the direction of gravity, the rotation angles of the window hinges etc.

The adjustment to the beam shape for example may comprise a rotation or zoom function to give beam broadening or narrowing of the whole beam, or it may involve providing adjustment of only one of the light output characteristics such as the peak intensity direction, beam width or cut-off angle.

The lighting unit may have a controllable output color, for example so that color temperature adjustment may be made for applications in which artificial lighting is matched with daylight lighting conditions. For this purpose, the daylight can be measured using an external light sensor. The color control may be limited to a tunable white output, but full color control may also be enabled using an RGB-based LED strip.

The LEDs themselves and their associated drivers may be entirely conventional. Similarly, the optics needed to define the desired light output characteristics explained above may be entirely conventional.

The lighting unit may comprise an LED strip formed as one or more rows of LED. The number and spacing of the LEDs will be selected to provide the desired overall light output and the desired lighting uniformity.

The lighting unit (and any sensors) may be powered by a local battery (and optionally also charged by a solar panel on the roof forming part of the window installation), or else internal wiring may be provided to the window location.

The examples above all show an openable window, and the handle is for opening the window. The same optical function may be desired for a non-opening roof window. In this case, a dummy handle may be installed of the type described above, but which performs only a lighting function and does not perform an opening function.

The handle may be provided as a part of a window, but it may also be provided as a retrofit item.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A window comprising:
a window pane;
an inner frame around the window pane, the inner frame having a first edge;
an outer frame, wherein the inner frame is openable within the outer frame;
a handle in the form of a bar extending along the first edge of the inner frame for use in opening the inner frame, wherein the handle is spaced at a perpendicular distance from the window pane; and
a lighting unit provided along the handle for providing illumination towards the window pane,
wherein the lighting unit is arranged to emit an output beam having a principal output direction, the principal output direction being at an angle with a plane parallel to the window pane, and
wherein the angle has a maximum value of 20 degrees.

2. A window as claimed in claim 1, wherein the perpendicular distance is in the range of 1 cm to 20 cm.

3. A window as claimed in claim 1, wherein the output beam has a half width half maximum on a side facing the window pane of less than 10 degrees.

4. A window as claimed in claim 1, wherein the output beam has a half width half maximum on a side facing away from the window pane in the range of 3 to 45 degrees.

5. A window as claimed in claim 1, wherein the inner frame has a second edge opposite to the first edge, and wherein the principal output direction is directed from the lighting unit to the second edge.

6. A window as claimed in claim 1, wherein the output beam has a cut-off angle with respect to the principal output direction of less than 70 degrees in the direction away from the window pane.

7. A window as claimed in claim 1, wherein the lighting unit generates a polarized light output such as an S-polarized light output.

8. A window as claimed in claim 7, wherein the window pane comprises a reflective polarizer.

9. A window as claimed in claim 1, further comprising blinds or curtains to be illuminated by the lighting unit.

10. A window as claimed in claim 1, further comprising:
a presence detection unit and/or an ambient light detection unit; and
a controller for controlling the lighting unit in dependence on the ambient light detection and/or presence detection.

11. A window as claimed in claim 1, further comprising:
an open or closed detection unit for detecting if the inner frame is open or closed; and
a controller for controlling the lighting unit in dependence on the open or closed detection.

12. A window as claimed in claim 1, wherein the lighting unit has an adjustable beam shape.

13. A window as claimed in claim 1, comprising a roof window which is adapted for mounting at an angle of between 30 and 60 degrees to the vertical.

14. A handle for attachment to a window, wherein the window comprises a window frame and a window pane, and wherein the handle comprises:
a bar for mounting along one edge of the window frame, wherein the handle is adapted to be spaced at a perpendicular distance from the window pane; and
a lighting unit provided along the handle for providing illumination towards the window pane, wherein the lighting unit is arranged to emit an output beam having a principal output direction which is adapted to be within 20 degrees of a plane parallel to the window pane.

15. A method of lighting an area of a window pane, comprising:
providing illumination towards the area of the window pane from a handle, wherein the handle extends along one edge of a frame which surrounds the area of the window pane, wherein the handle is spaced at a perpendicular distance from the window pane, and wherein the illumination has a principal output direction which is within 20 degrees of a plane parallel to the area of the window pane.
